(19) United States
(12) Patent Application Publication
(10) Pub. No.: US 2024/0211746 A1
(43) Pub. Date: Jun. 27, 2024

(54) REALISTIC SAFETY VERIFICATION FOR DEEP REINFORCEMENT LEARNING

(71) Applicant: International Business Machines Corporation, Armonk, NY (US)

(72) Inventors: Kevin Eykholt, White Plains, NY (US); Wenbo Guo, State College, PA (US); Taesung Lee, Ridgefield, CT (US); Jiyong Jang, Chappaqua, NY (US)

(21) Appl. No.: 18/086,921

(22) Filed: Dec. 22, 2022

(51) Int. Cl. G06N 3/08; G06N 3/047

(52) U.S. Cl. CPC G06N 3/08; G06N 3/047

(57) ABSTRACT

Safety verification for reinforcement learning can include receiving a policy generated by deep reinforced learning, where the policy is used in acting in an environment having a set of states. Responsive to determining that the policy is a non-deterministic policy, the non-deterministic policy can be decomposed into a set of deterministic policies. Responsive to determining that a state-transition function associated with the set of states is unknown, the state-transition function can be approximated at least by training a deep neural network and transforming the deep neural network into a polynomial. Using a constraint solver the policy with the state-transition function can be verified. Runtime shielding can be performed.

### BACKGROUND

The present application relates generally to computers and computer applications, and more particularly to safety verification for deep reinforcement learning.

Advancements in reinforcement learning (RL) have expedited its success across a wide range of decision-making problems. However, a lack of safety guarantees restricts its use in tasks. Reinforcement learning (RL) can be implemented for various sequential decision-making problems, such as training artificial intelligent (AI) agents to defeat professional players in sophisticated games and controlling robots to accomplish complicated tasks. However, ensuring that RL agents do not enter undesirable states is difficult due to the unpredictable nature of supervised policies, use of non-determinism to encourage exploration, and the long-term consequence of seemingly safe actions. This uncertainty raises safety and security concerns that limit their applicability in application fields such as cyber security, self-driving cars, and finance.

### BRIEF SUMMARY

The summary of the disclosure is given to aid understanding of a computer system and method of enabling realistic safety verification for deep reinforcement learning, and not with an intent to limit the disclosure or the invention. It should be understood that various aspects and features of the disclosure may advantageously be used separately in some instances, or in combination with other aspects and features of the disclosure in other instances. Accordingly, variations and modifications may be made to the computer system and/or their method of operation to achieve different effects.

A method, in an aspect, can include receiving a policy generated by deep reinforced learning, the policy for acting in an environment having a set of states. The method can also include, responsive to determining that the policy is a non-deterministic policy, decomposing the non-deterministic policy into a set of deterministic policies. The method can further include, responsive to determining that a state-transition function associated with the set of states is unknown, approximating the state-transition function at least by training a deep neural network and transforming the deep neural network into a polynomial. The method can also include verifying using a constraint solver the policy with the state-transition function.

A system, in an aspect, can include at least one processor. The system can also include a memory device coupled with at least one processor. At least one processor can be configured to receive a policy generated by deep reinforced learning, the policy for acting in an environment having a set of states. At least one processor can also be configured to, responsive to determining that the policy is a non-deterministic policy, decompose the non-deterministic policy into a set of deterministic policies. At least one processor can also be configured to, responsive to determining that a state-transition function associated with the set of states is unknown, approximate the state-transition function at least by training a deep neural network and transforming the deep neural network into a polynomial. At least one processor can also be configured to verify using a constraint solver the policy with the state-transition function.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 illustrates an example computing environment according to one embodiment.

FIG. 2 shows system architecture for safety verification in deep reinforcement learning in an embodiment.

FIG. 3 shows a polynomial approximation in an embodiment. FIG. 4 is a diagram illustrating a method in an embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as realistic safety verification for deep reinforcement learning algorithm code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

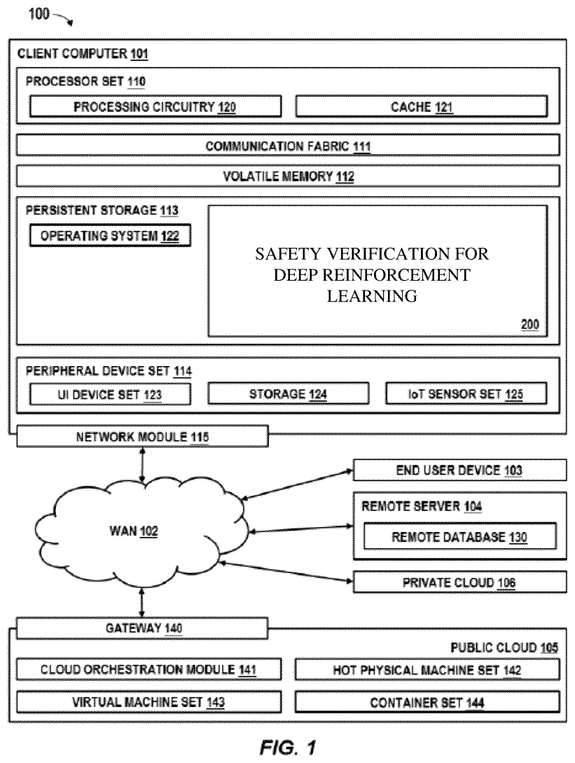

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The following terms are used in relation to deep reinforcement learning (DRL). Environment as used herein in relation to DRL refers to the surroundings or conditions in which an agent operates or takes its actions. State refers to the current situation of the agent. Policy refers to a method or mapping that maps agent's state to action or actions.

One or more systems, methods, techniques can be provided for verifying deep reinforcement learning (DRL) policies, for example, so that a DRL agent in operation avoids falling into undesirable states. Reinforcement learning (RL) is machine learning which teaches an agent to learn to operate in the real world or in its environment. For example, an RL algorithm may teach a robot to navigate in a room via a series of actions, so as to avoid obstacles and operate for its purpose. For instance, a policy specifies an action to take, given a state. A policy can be trained. For example, RL or DRL can train or learn policies.

A safety verification process for DRL targets to provide verifications of policies or DRL trained policies. Ideally, safety guarantees should, given an environment with a set of predefined safe and unsafe states, make sure the agent never falls into unsafe states. Such safety guarantees may not be easy to implement given the real-world scenarios in which there can be non-deterministic policies and unknown state transitions. Non-deterministic policies refer to policies where there are a set of actions that can be taken and an action can be chosen from the set, for example, using or based on probability. In known state transitions, how an environment behaves is known or there is an exact equation for the behavior, e.g., how states transition from one to another in an environment based on actions taken. Contrarily, in unknown state transitions, transitions of states are not known, e.g., it is not known exactly how an environment behaves, e.g., there is no exact equation for the environment's behavior. That is, in the real world environment, whether a policy when run would behave as expected, may not be known. In one or more embodiment, a verification algorithm can be provided that allows to perform safety verifications even in scenarios where the DRL policy is non-deterministic or state transition is unknown.

Methods and techniques can be provided that address a safety guarantee for deep reinforcement learning (DRL) systems even with non-deterministic policies and unknown state transition functions. For example, properties of known state-transition function and deterministic reinforcement learning policy may not be true in real environments. Techniques are described herein, which can provide safety verifications in more realistic environments. For example, the state-transition function of most RL tasks is unknown, even in simulation environments and, instead, must be observed, for example, after an action takes place. For complex tasks, effective policies can be non-deterministic.

A safety verification method described herein can work unknown state-transition functions. A safety verification method described herein can also work with non-deterministic RL policies running in an environment, for example, whether the state-transition is known or unknown.

In an embodiment, the method can build upon post-training verification methods. For example, in post-training verification methods, given a well-trained agent, these methods create a program that approximates the agent's policy. The safety of the program is verified, and the program is shielded so that the agent is guaranteed to be safe with respect to a set of safety conditions. If running an action from the original policy would violate the safety conditions, an action is instead drawn from the shielded program policy.

The method disclosed herein in an embodiment can extend this verification approach with a set of approximation strategies, which allows the verification of non-deterministic policies in environments with unknown state-transition functions. If a non-deterministic policy is given, the method can transform the original policy into a categorical combination of two or more deterministic policies. The method can verify the safety of each deterministic policy and generate the respective shielding policy and safety conditions using existing solvers. With respect to environments with an unknown state-transition function, the method can include approximating the unknown state-transition function with a neural network trained on observations of the state-action pairs. Once trained, the method can use a Taylor approximation to express the neural network as a polynomial function, which existing solvers can use for verification. At runtime, the method can check if the action produced by the non-deterministic policy (agent acting on the policy) violates the safety conditions of the underlying deterministic policy most likely to produce the action, and if so, use the corresponding shielding policy.

In one or more embodiments, approximation strategies are disclosed that improve safety verification of reinforcement learning (RL) policies. The approximation strategies can relax assumptions about the agent's policy and the state-transition function. The policy decomposition and state-transition approximation methods transform the RL problem into a form that existing solvers can process. By augmenting state-of-the-art verification techniques with disclosed approximation strategies, the technique can guarantee the safety of non-deterministic RL policies operating in environments with unknown state-transition functions. The technique can guarantee the safety of an RL policy at runtime. For instance, the verification method can provide a safety guarantee for a non-deterministic policy acting in an environment with an unknown state-transition function. Experiments on three representative RL tasks empirically verify the efficacy of the method in providing a safety guarantee to a target agent while maintaining its task execution performance. For instance, the experiment results validate the effectiveness of the method with regard to runtime safety, while preserving the performance of the original agent.

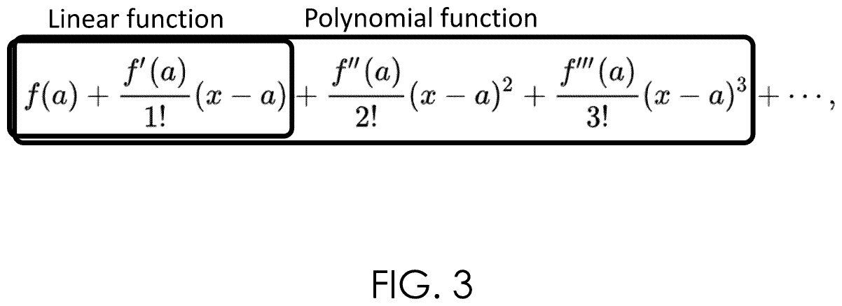

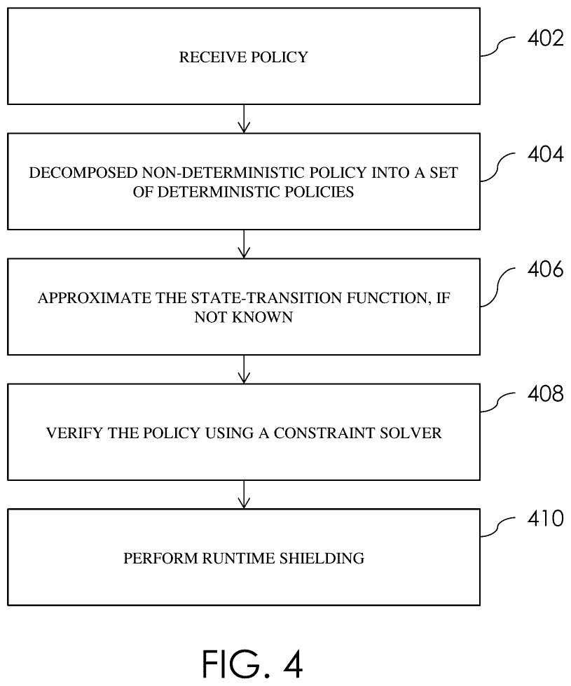

In an embodiment, state-transition approximation can approximate a state transition using machine learning. State transition approximation collects a trajectory, which includes state action sequences, current state, the action performed, and subsequent state (what happened after taking that action). State transition approximation can also include, given the state at time step t. and action performed, training a model such as a neural network or deep neural network, to predict what the next state is going to be, e.g., state at time step t+1. State transition approximation, by training and using such a model, can create a close approximation of a state-transition function, which allows for running a verification process even when the exact transition function is not known. For example, a series of observations can be made and then an approximation of the observations can be trained. In an embodiment, the neural network model can be approximated with a polynomial using an N-th-order Taylor approximation, where N is an integer. This approximation process transforms the neural network or DNN into a polynomial using Taylor approximation. Approximating the neural network model with a polynomial allows for using existing verification techniques, which may require the state transition function be expressed as a polynomial. FIG. 3 shows a polynomial approximation in an embodiment. As the precision of the approximation is increased, better versions of state-transition approximation can be created for the verification.

State-transition approximation can include the following algorithm:

| | |
|---|---|
| 1. | Using the original policy P, collect a set of trajectories T. A trajectory is the state-action |
| | sequence for an episode. |
| 2. | Using the collected trajectories, train a deep neural network (DNN) F: F(sₜ, aₜ) = sₜ₊₁. State |
| | transition function models the deep reinforcement learning (DRL) environment, where the |
| | function (F) takes as input the current state and action (sₜ, aₜ) and outputs the next state (sₜ₊₁). |
| 3. | Approximate the trained DNN with a polynomial using an N^{th}-order Taylor approximation. |

For addressing a non-deterministic policy, in an embodiment, the non-deterministic policy can be broken down into linear combinations of deterministic policies. For example, a method can be designed to decompose a non-deterministic policy into a combination of deterministic policies. Existing algorithms or constraint solvers can be used to verify a deterministic policy. There can be two types of non-deterministic policies or policy structures. Type 1 non-deterministic policies can include a probabilistic combination of deterministic policies (e.g., there is 50% chance of performing action from policy 1 and 50% chance of taking an action from policy 2). For this type (type 1), the policies can be split, and each policy verified separately. Type 2 non-deterministic policies can include a probability distribution from which sampled values are mapped to actions, e.g., a probability distribution from where actions are randomly sampled. For type 2, the distribution can be segmented into a number of regions, e.g., n regions. The number can be predefined or preconfigured. In an aspect, the more regions there are, the more precise the approximation can be. A sample can be selected from each region to represent the action from that region. For example, considering a curve as a distribution, that curve can be segmented into n regions, for example, 4 regions. In an embodiment, a mean value can be used from each segment or region to select a representative action from the region. In another embodiment, a mode value (e.g., most common value) can be used from each segment or region to select a representative action from the region. Another method can be used to select a representative action from a region. Selecting an action from each segmented region results in deterministic policies from each of the regions. These actions are now within type 1 policy, i.e., probabilistic combinations of deterministic policies. The safety of each of those policies can be verified using existing methods.

The following describes an algorithm for policy decomposition. In the algorithm, PLᵢ denotes a linear program (i.e., approximation of the deterministic policy). The verification algorithm in 4b uses this approximation to evaluate the set of conditions that need to be true to guarantee that PLᵢ always results in safe state.

| 1. | Given a non-deterministic policy P (also referred to as π), if it is a type 2 policy, divide the | |
|---|---|---|
| | probability distribution into K regions. Otherwise, skip to step 4. | |
| 2. | Select a sample from each region to represent the action produce by the region. | |
| 3. | Form K deterministic policies using the representative samples chosen in step 2. The | |
| | probability of selecting a deterministic policy is based on the area of the corresponding | |
| | region. | |
| 4. | For each deterministic policy Pi, where i can be 1 to K (also referred to as πₖ, where k can | |
| | be 1 to K): | |
| | a. | Approximate the policy with a program PLᵢ, a linear approximation of the deterministic |
| | | policy Pi (also referred to as πₗₖ). |
| | b. | Verify the safety of PLᵢ and its inductive invariant Φᵢ. |

In an embodiment, part of verification can include runtime shielding. Runtime shielding can be a fail-safe. For example, if the original policy or action that is being verified if run would fall into an unsafe state, runtime shielding allows to correct the original policy's unsafe action. For instance, given a pre-trained policy, runtime shielding can be performed to ensure that even if the pre-trained policy would have taken an unsafe action, there is a fail-safe that would then correct the unsafe action. Runtime shielding can be run to eliminate any failed states. In an aspect, runtime shielding can function as a backup. For example, a policy can be simulated and checked as to whether the policy entered an unsafe state. If the policy entered an unsafe state, runtime shielding can specify, for that specific case, to use a backup action instead of the action specified in the policy.

Runtime shielding can include the following:
1. Generate an action a for the current state sₜ from the non-deterministic policy P (also referred to as π).
2. Identify Pⱼ, the decomposed deterministic policy most likely to generate a: j=argminₖ∥P(sₜ)−Pₖ(sₜ)∥₂
3. Predict the next state sₜ₊₁ that would result from a.
4. Check if Φᵢ(Sₜ₊₁) is true. If so, run a. Otherwise, run Pₗₖ(sₜ).

An algorithm in one or more embodiments verifies safety of a policy with a stochastic policy and unknown state transition function. The algorithm may use a deep neural network (DNN) to approximate the original policy. For example, for unknown state-transition functions, the algorithm may take a series of observations about the environment and then train a model to approximate a function based on the observations. The algorithm may also approximate the DNN with a Taylor approximation. The algorithm may further treat policy as a mixture of deterministic policies or a sampling process from a probability density distribution.

In an embodiment, a method can be presented for creating a safety verified decision-making model using deep reinforced learning where the reinforcement learning policy is non-deterministic and/or the state transition function is unknown. The method can include receiving a non-deterministic policy generated by a deep reinforced learning system or algorithm. The method can also include testing the non-deterministic policy to determine whether it is a probabilistic combination of deterministic policies or a probability distribution from which sampled values are mapped to actions. The method can also include, if the non-deterministic policy is a probability distribution, dividing the probability distribution into a plurality of regions, selecting a sample from each region to represent an action from that region, forming a deterministic policy for each of the plurality of regions using the selected samples. The method can also include, for each deterministic policy, approximating the policy with a linear program, and verifying the safety of the linear program and its inductive variant. The method can also include generating a known state transition function by generating a set of state-action trajectories using the received non-deterministic policy, training a deep neural network using the set of state-action trajectories, and generating a known state transition function by approximating the trained deep neural network with a polynomial using an n-th order Taylor approximation. The method can also include performing runtime shielding by generating an action for the current state using the non-deterministic policy, determining the decomposed deterministic policy most likely to generate the generated action, predicting the next state that would result from the action given the known state transition function, testing the inductive variant of the determined decomposed deterministic policy with the predicted next state. The method can also include, if the inductive invariant testing is true, running the generated action. Otherwise, the method can generate a safe action with the determined decomposed deterministic policy and run that safe action.

Deep Reinforcement Learning (DRL) concerns the sequential decision-making problems, where the environment is usually modeled as a Markov Decision Process (MDP).
Definition 1 (Markov Decision Process). A Markov Decision Process (MDP) is comprised of a 4-tuple ( [symbol] F), in which [symbol] represents the state space, [symbol] denotes the action space, [symbol] × [symbol] → [symbol] is the reward function, and F: [symbol] × [symbol] → [symbol] refers to the state-transition function.

The goal of training a DRL agent is to learn a neural policy π_{θ}(a|s) that maximizes its expected total reward collected from a sequence of actions generated by that policy. There can be two main categories of training algorithms: deep Q-learning and policy-gradient methods.

Safety Verificaiton of a RL Policy is described herein. In addition to training an agent to maximize its expected rewards, the agent is also encouraged to avoid reaching certain undesirable states. While reward penalties can be used to discourage such actions, they do not guarantee an undesirable state will never be reached. Thus, methods can be developed to provide formal safety guarantees with respect to an agent's behavior. Safety can be formally defined as follows:
Definition 2 (Safety of a DRL Policy). Given a MDP with the state space [symbol] , a set of user defined initial states [symbol] ₀, a set of user-defined unsafe states [symbol] ᵤ, if one can start from any state s∈ [symbol] ₀ and never reach a state s∈ [symbol] ᵤ after following any possible sequence of actions generated from policy π, then one can define policy π as safe.

With this definition of safety, a verification method can verify the safety of a pre-trained deterministic RL policy with a known transition function. This method can be broken into three steps: Program Learning, Program Verification, and Runtime Shielding. At a high level, this method performs a programmatic approximation of the neural policy. Then, the method verifies the safety of the program and generates an additional shielding policy along with a set of safety conditions. At runtime, the original neural policy is augmented with the shielding policy, which only runs if the neural policy's action would violate the safety conditions of the shielding policy. A method disclosed herein can use this underlying verification strategy, and further includes techniques to allow for the verification of non-deterministic RL policies even with unknown state-transition functions.

Program Learning. Given a deterministic neural policy π, program learning synthesizes a linear program πₗ(s)::=return θₗs, to mimic π where s∈ [symbol] is a state and θₗ is an imitation learning parameter. θₗ is learned by solving the following objective function:

$${θ}_{l} = argmax d ( π , {π}_{l} , 𝒯 ) , \qquad ( 1 )$$

$$d ( π , {π}_{l} , 𝒯 ) = {\sum }_{T ∈ 𝒯} {\sum }_{t ∈ 𝒯} \{ \begin{matrix}- {‖ π ( {s}_{t} ) - {π}_{l} ( {s}_{t} ) ‖}_{2} & {s}_{t} ∉ {𝒮}_{u} \\ - MAX & {s}_{t} ∈ {𝒮}_{u}\end{matrix} ,$$

where [symbol] is a set of trajectories collected by running π in the corresponding environment. This objective function penalizes action differences of π and πₗ at the safe states.

Program Verification. By combining the linear program πₗ defined above with the system's state-transition function F, the method can define a state-transition function Fry, such that sₜ₊₁=F_{π}_{ₗ}(sₜ)=F(sₜ, πₗ(sₜ)).

Program verification involves learning an inductive invariant ϕ, such that: 1) ϕ is disjoint with all unsafe states [symbol] ᵤ, 2) ϕ includes all initial states [symbol] ₀, and 3) all possible state transitions expressed by F_{π}_{ₗ} is encapsulated in ϕ. Formally, ϕ::=E(s)≤0 defines an inductive invariant where E(s): [symbol] ⁿ→ [symbol] is a polynomial function that satisfies the following conditions:

$$∀ s ∈ {𝒮}_{u} E ( s ) > 0 , ∀ s ∈ {𝒮}_{0} E ( s ) \leq 0 , \qquad ( 2 )$$

$$∀ ( s , {s}^{′} ) ∈ {F}_{{π}_{l}} E ( {s}^{′} ) - E ( s ) \leq 0 .$$

As both F_{π}_{ₗ} and E are polynomial functions, an Satisfiability Modulo Theories (SMT) solver can be used to find such an E that satisfies the conditions in Eqn. (2). In cases where the SMT solver cannot find a feasible solution, a Counterexample-guided Inductive Synthesis algorithm can be used.

Runtime Shielding. Runtime shielding uses the synthesized program πₗ and learned inductive invariant ϕ to guarantee the safety of the neural policy at runtime. As the neural policy is likely to have better performance, at each time step t, the method can first generate an action from the neural policy π(sₜ) and predict the next state sₜ₊₁ resulting from the generated action. If the predicted next state sₜ₊₁ satisfies the inductive invariant (i.e., E(sₜ₊₁)≤0), then the method can take the action. Otherwise, the method can generate an action from the synthesized program πₗ as its safety has been verified. In general, πₗ acts as a backup policy whenever the safety of the neural policy's action cannot be confirmed.

A method in an aspect can enable realistic safety verification of RL policies. In an embodiment, the method can build upon post-training safety verification methods, for example, where the verification method V takes as input a polynomial state-transition function F and a deterministic policy π. The verification process outputs a shielding policy πₗ and the safety condition (i.e., inductive invariant ϕ) under which πₗ should be run instead of π. Augmenting π with πₗ and ϕ can guarantee safety in simple and unrealistic scenarios.

The method in an embodiment relaxes the requirement that the policy be deterministic and the system transitions be known as such conditions are unlikely to be satisfied in complex, real deployments. Relaxing such requirement can improve the practicality of V. In an embodiment, the method decomposes a non-deterministic policy into a probabilistic combination of multiple deterministic policies. After decomposition, the method can reuse verification methods (which work on deterministic policies) to individually safeguard each deterministic policy with an associated shielding policy. At runtime, the method can use a modified run-time shielding strategy to guarantee the safe run of a non-deterministic policy using the decomposed deterministic policies and their respective shielding policies.

The method can also include a two-step approximation method, which can enable safety verification in environments with unknown state-transition functions. The method can run the pre-trained neural policy π in the corresponding environment and collect a set of trajectories [symbol] The corresponding environment refers to an operating environment of an RL agent, which can be a simulated environment and/or a real environment. These trajectories are used to fit a neural network N_{θ}. parameterized by θ, which takes as input the state and action at time step t and output the predicted state of the next time step t+1. This neural network can now be used as an approximation to the environment's unknown state-transition function F_{π}. For verification techniques that work only for systems with polynomial state transitions, the neural network may not be directly used for verification. In such cases, the method can approximate the trained neural network N_{θ} with a polynomial function Ñ through Taylor expansion. This final polynomial approximation can be used with existing verification methods. In an aspect, the method may not directly approximate [symbol] with polynomial functions because, compared to DNNs, polynomial functions have a limited capability in approximating complicated functions and handling high-dimensional inputs.

Relaxing assumptions or requirements that a policy be deterministic and that state-transition be known to perform safety verification of a pre-trained RL policy, is described in detail herein. For example, the method can perform a policy decomposition that transforms a non-deterministic policy into a set of known deterministic policies. The method can also perform a state-transition approximation that produces a polynomial approximation of an unknown state-transition function using a series of observations. In both cases, the method can result in transforming the system into a form that enables the reuse of verification techniques, which may assume a deterministic policy and known state-transition function.

Policy Decomposition. Given a non-deterministic policy π, the method can consider two common structures:
N1: π is a combination of K known deterministic policies. At runtime, first, one of the constituent deterministic policies π₁, . . . , π_{K} is selected according to a categorical distribution. Then, π returns the action generated by the selected deterministic policy.
N2: π is a probability distributions in which values from the distribution can be directly mapped to an action in a continuous action space. At runtime, an action is drawn from the probability distribution.

N1 is often used as a mixture policy that combines different policy types, such as a neural policy and a rule-based policy, thus leveraging their complementary strengths. As N1 is a combination of K known deterministic policies, the method can directly decompose π in its constituent policies π₁, . . . , π_{K} and perform verification on each decomposed policy.

N2 draws an action directly from a probability distribution, such as a Gaussian distribution. For example, the rotation degree of the steering wheel can be randomly chosen from a Gaussian policy trained by the Proximal Policy Optimization (PPO) algorithm. To decompose N2, the method in an embodiment can divide a continuous non-deterministic policy (e.g., Gaussian or more generally exponential family distributions) into several regions and represent each region with a fixed sample. In doing so, the policy is approximated as probabilistic combination of a set of fixed samples, which can be thought of as a combination of deterministic policies (i.e., an N1 policy structure) and be verified as such. By way of example, using Gaussian distribution is described to illustrate a technical approach. Given a Gaussian policy π with mean μ and variance σ², the method can divide its probability density function into K bins of equal area. Thus, if the method draws a sample from π, it will be equally likely to belong to any of the bins. Then, the method can select a sample from each bin to represent the bin's region, denoted as μ₁, . . . , μ_{K}. With these representative samples, the original Gaussian distribution can be approximated as a categorical distribution across the representative samples μ₁, . . . , μ_{K} with a equal probability 1/K to be selected. As part of the decomposition process in an embodiment, the method ensures that the mean and variance of the categorical distribution matches with that of the original policy π, i.e., the following equations hold:

$${\sum }_{k} {μ}_{k} \frac{1}{K} = μ , {\sum }_{k} {( {μ}_{k} - μ )}^{2} \frac{1}{K} = {σ}^{2} . \qquad ( 3 )$$

To make sure μₖ reflects the statistical significance of the k-th bin, the method can use either the mean or the mode of the first K−1 bins as μ₁, . . . , μ_{K-1}, and compute uk based on Eqn. (3).

There can be another type of non-deterministic policies that use N2-type policies as the part of the constituent policies in N1 to encourage both exploratory and exploitation (e.g., the ϵ-greedy approach). The method disclosed herein can also be used with such cases as policy decomposition can be recursively performed for each N2-type sub-policy.

State-transition Approximation. Given an unknown state-transition function, the method can perform a two-step approximation process to obtain a polynomial state-transition function. The first step is to train a neural network Ne to mimic the unknown state-transition function. The method can collect a dataset of M trajectories [symbol] by running the original policy π in the environment. A trajectory T∈ [symbol] can include a sequence of the state and selected action at each time step, i.e., {s₀, a₀, s₁, a₁, . . . , s_{|T|-1}, a_{|T|-1}, s_{|T|}}. The neural network is trained on [symbol] using the following objective function:

$$arg {min}_{θ} \frac{1}{M} {\sum }_{T ∈ 𝒯} \frac{1}{\vert T \vert} {\sum }_{t ∈ 𝒯} {‖ {s}_{t + 1} - {N}_{θ} ( [ {s}_{t} , {a}_{t} ] ) ‖}_{2}^{2} , \qquad ( 4 )$$

where [sₜ, aₜ] is the concatenation of sₜ and aₜ. Eqn. (4) updates θ to minimize the mean squared error between the true next state sₜ₊₁ and the prediction given by N_{θ}. Once trained, the second step of the approximation process is to transform the neural network N_{θ} into a polynomial function Ñ using a I-th order Taylor approximation:

$$\tilde{N} ( x ) = {\sum }_{i = 0}^{I} \frac{{N}_{θ}^{( i )} ( [ {s}_{t} , {a}_{t} ] )}{i !} {( x - [ {s}_{t} , {a}_{t} ] )}^{i} , \qquad ( 5 )$$

The method can use the Taylor approximation because of its flexibility. By varying I, the method can increase or decrease approximation accuracy at the cost of complexity. As Ñ is a polynomial function, it can be used during verification to approximate the unknown state-transition function.

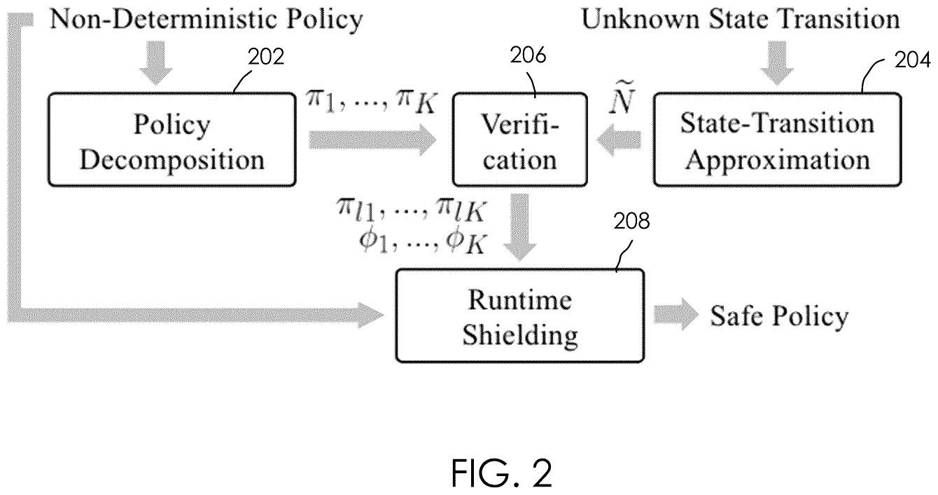

FIG. 2 shows system architecture in an embodiment. Components shown can be computer modules or like, for example, which can be implemented by one or more computers or processors described with reference to FIG. 1, and can perform safety verification described herein. Given a policy π acting in an arbitrary environment with a set of user-defined initial states [symbol] ₀ and unsafe states [symbol] ᵤ, the system identifies whether policy decomposition 202 and/or state-transition approximation 204 should be performed. If so, the system can use a method described herein to generate a set of deterministic policies π₁, . . . , π_{K} and/or a polynomial state-transition function. For instance, if the given policy is non-deterministic, then policy decomposition 202 is determined to be performed as described above. For example, if the given policy π provides variable outputs for the same input, then that policy can be considered as non-deterministic. If the given states have unknown state-transition function, then state-transition approximation 204 is determined to be performed as described above. For example, if no state-transition function is input for verification or if a state-transition function does not exist, it can be determined that the state-transition function is unknown. Then, using a verification strategy 206, each deterministic policy Ik can be processed and an alternative shielding policy πₗₖ and its corresponding safety condition/inductive invariant ϕₖ can be generated.

Runtime Shielding 208. During runtime, at each time step t, the system can generate an action using policy π(sₜ). Then, the K underlying deterministic policies the action was most likely to be sampled can be identified using the following equation:

$$j = arg {min}_{k} {‖ π ( {s}_{t} ) - {π}_{k} ( {s}_{t} ) ‖}_{2} \qquad ( 6 )$$

where j is the index of the identified policy πⱼ. The system can check if the action satisfies ϕⱼ, the inductive invariant of πⱼ. If ϕⱼ holds, the system can take the action π(sₜ). Otherwise, the system can take the action πₗⱼ(sₜ).

Theorem 1 (Safety Guarantee). Following the above runtime shielding strategy, the policy π and the programmatic policies {πₗ₁, . . . , π_{lK}} in the environment guarantee that the agent never falls into any unsafe states, i.e., ∀sₜ, ϕ₁(sₜ)∨ . . . ∨ϕ_{K}(sₜ) is True.

Proof. The above theorem can be proven using the mathematical inductive method. At any initial state s₀∈ [symbol] ₀, it is known that ϕ₁(s₀)∧ . . . ∧ϕ_{K}(s₀) is True by definition. Now, at some arbitrary time t, assume ϕ₁(sₜ)∨ . . . ∨ϕ_{K}(sₜ) is True. Since ϕ₁(sₜ)∨ . . . ∨ϕ_{K}(sₜ) is True, it can be known that for some value k, ϕₖ(sₜ) is also true. According to Eqn. (2), there is Eₖ(sₜ₊₁)−Eₖ(sₜ)≤0 and as known Eₖ(sₜ)≤0, it must also be True that Eₖ(sₜ₊₁)≤0. This means that ϕ₁(sₜ₊₁) is True. Since ϕ₁(sₜ₊₁)∨ . . . ∨ϕ_{K}(sₜ₊₁) holds for t+1, it can be concluded that ∀t∈ [symbol] ⁺, ϕ₁(sₜ)∨ . . . ∨ϕ_{K}(sₜ) is True.

FIG. 4 is a diagram illustrating a method in an embodiment. The method can provide a safety verification of deep reinforcement learning (DRL), even in the presence of one or more non-deterministic policies and/or unknown state-transition function. At 402, a policy generated by deep reinforced learning is received, e.g., the policy for acting in an environment having a set of states. The policy maps actions performed in an environment to states, e.g., in the set of states.

At 404, responsive to determining that the policy is a non-deterministic policy, the non-deterministic policy is decomposed into a set of deterministic policies. Decomposing of the policy into the set of deterministic policies can be done by dividing a probability distribution associated with the non-deterministic policy into a plurality of regions. From each of the plurality of regions, a sample can be selected, such that the set of deterministic policies includes a sample selected from each of the plurality of regions. In an embodiment, the sample represents a mean of a region from which the sample is selected. In another embodiment, the sample represents a mode of a region from which the sample is selected.

At 406, responsive to determining that a state-transition function associated with the set of states is unknown, the state-transition function is approximated at least by training a deep neural network and the deep neural network is transformed into a polynomial, e.g., polynomial state-transition function. For example, approximating the state-transition function can be done by collecting a set of trajectories by running the policy in the environment, where the set of trajectories includes a sequence of state and action at each time step. The deep neural network can be trained based on the set of trajectories to predict a next state at next time step. Parameters of the deep neural network can be transformed into a polynomial function using an I-th order Taylor approximation.

At 408, using a constraint solver, the policy with the state-transition function can be verified. Any known or will be known constraint solver can be used for verifying the policy. Where the state-transition function is unknown, the polynomial function generated at 406 can be used as the state-transition function during the verification.

At 410, runtime shielding can be performed. For example, runtime shielding can be done by, at a time step during runtime, generating an action for current state using the policy. From the set of deterministic policies, a deterministic policy most likely to produce the generated action can be identified. A next state that would result from the action given the state-transition function can be predicted. An inductive invariant of the identified deterministic policy with the predicted next state can be checked. Responsive to the inductive invariant of the identified deterministic policy holding true, the generated action can be run. Otherwise, e.g., responsive to the inductive invariant of the identified deterministic policy not holding true, a safe action corresponding to the identified deterministic policy can be generated and the safe action can be run.

In one or more embodiments, the safety verification for deep reinforcement learning and provide for controlling or allowing an automated agent in performing an action in a safe manner in a realistic world environment, for example, where there may not always be deterministic policies and known state-transition functions. The safety verification disclosed herein further improves the deep reinforcement learning technique by allowing for safety verifications in such a realistic world environment.

The following illustrates in detail example use case experimentations of the system and/or method described herein. For instance, example use case experimentations include three enviroments where the system and/or method are used: cartpole, pendulum, and carplatoon. The system and/or method can be evaluated using a non-deterministic policy both when the state-transition function is known and unknown. In the following, these environments and their safety conditions are introduced followed by the design and results of the experiments. It should be understood that the system and/or method can be applicable to wide range of environments, and are not limited to the example environments described herein.

CartPole. This environment has a pole standing on top of a cart. The RL agent can move the cart horizontally along a frictionless track to keep the pole upright. The system is in an unsafe state if the angle of the pole is more than 30 degrees from being vertical or the cart moves more than 0.3 meters from the origin.

Pendulum. This environment contains a pendulum, starting at a random position and rotating around the circle center. The RL agent swings the pendulum to keep the pendulum upright. The system is in an unsafe state if the pendulum's angle is more than 23 degree from being upright.

Carplatoon. This environment models a real-world scenario where 4 cars form a platoon on a road and drive along the same direction. The RL agent can modify the horizontal and vertical speed of each car The system is in an unsafe state if the relative distance between two cars is less than a certain number (threshold).

In the above three environments, an episode directly terminate if it enters any unsafe state; otherwise, it will terminate when the agent's reward reaches a pre-defined value or if the max episode length is reached.

Evaluation Metrics. The safety verification method can be evaluated on three aspects—task performance, efficiency, and safety. Task performance is measured by the average number of steps per episode required to complete the task, i.e., the number of steps needed for a good termination (Avg. Steps). A smaller number means the agent could finish the task quicker, indicating better performance. Efficiency is measured by the average run time before termination of each episode (Avg. Runtime(s)). The safety is measured by the number of episodes in which the agent entered an unsafe state (Failure Count).

In experiments where non-deterministic policy with a known state-transition function is used to test the runtime shielding method and policy decomposition strategy, experimental results show that the safety verification method described herein can preserve the performance of the original policy while ensuring safety. These results confirm the effectiveness of the method's runtime shielding and policy decomposition. In an aspect, the system and/or method need not be sensitive to the choice of K and mean/mode, thereby exhibiting property that users do not need to exhaustively search for an ideal set of hyper-parameters to obtain a desired performance when using the system and/or method.

Similarly, performance measurements of the system and/or method described herein, where the experiments used non-deterministic policy with an unknown state-transition function, show that the system and/or method is able to ensure the safety of each non-deterministic policy and maintain the similar task performance with respect to average steps. Further, results show that the approximation strategy for approximated state-transition functions produces accurate approximations when the state-transition function is unknown.

In an aspect, the system and/or method may consider leveraging more efficient computation methods to reduce the runtime overhead, if the environment involves a higher-order approximation such as a second-order approximation, which requires computing the Hessian matrix. In an aspect, other optimizaiton and/or numerical methods that can be used to enable a higher-order polynomial approximation can be considered. In another aspect, the system and/or method may consider transforming an original multi-player environment into a single-player environment for the target player (agent) and then apply our method to safeguard that agent in the transformed environment. Yet in another aspect, the system and/or method may divide the initial states into subsets and conduct an approximation for each subset. This may enable an accurate approximation of the original state-transition function and may generalize the method method to complicated systems as well. For example, the method may conduct a piece-wise approximation and extend runtime shielding strategy to utilize the programs obtained from each approximated state-transition function. Yet in another aspect, a policy decomposition strategy may be designed for non-deterministic policies with a categorical distribution so that the decomposed policies can be used with existing constraint solvers. Still in another aspect, the system and/or method may be adapted to also improve training-phase verification techniques, e.g., in addition to post-training verification.

The terminology used herein is for the purpose of describing particular embodiments only and is not intended to be limiting of the invention. As used herein, the singular forms “a”, “an” and “the” are intended to include the plural forms as well, unless the context clearly indicates otherwise. As used herein, the term “or” is an inclusive operator and can mean “and/or”, unless the context explicitly or clearly indicates otherwise. It will be further understood that the terms “comprise”, “comprises”, “comprising”, “include”, “includes”, “including”, and/or “having.” when used herein, can specify the presence of stated features, integers, steps, operations, elements, and/or components, but do not preclude the presence or addition of one or more other features, integers, steps, operations, elements, components, and/or groups thereof. As used herein, the phrase “in an embodiment” does not necessarily refer to the same embodiment, although it may. As used herein, the phrase “in one embodiment” does not necessarily refer to the same embodiment, although it may. As used herein, the phrase “in another embodiment” does not necessarily refer to a different embodiment, although it may. Further, embodiments and/or components of embodiments can be freely combined with each other unless they are mutually exclusive.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method comprising:
receiving a policy generated by deep reinforced learning, the policy for acting in an environment having a set of states;
responsive to determining that the policy is a non-deterministic policy, decomposing the non-deterministic policy into a set of deterministic policies;
responsive to determining that a state-transition function associated with the set of states is unknown, approximating the state-transition function at least by training a deep neural network and transforming the deep neural network into a polynomial; and
verifying using a constraint solver the policy with the state-transition function.

2. The method of claim 1, wherein the decomposing of the policy into the set of deterministic policies includes:
dividing a probability distribution associated with the non-deterministic policy into a plurality of regions;
from each of the plurality of regions, selecting a sample,
wherein the set of deterministic policies includes the sample from each of the plurality of regions.

3. The method of claim 2, wherein the sample represents a mean of a region from which the sample is selected.

4. The method of claim 2, wherein the sample represents a mode of a region from which the sample is selected.

5. The method of claim 1, wherein the approximating the state-transition function includes:
collecting a set of trajectories by running the policy in the environment, the set of trajectories including a sequence of state and action at each time step;
training the deep neural network based on the set of trajectories to predict a next state at next time step; and
transforming parameters of the deep neural network into a polynomial function using a I-th order Taylor approximation,
wherein the polynomial function used during the verifying as the state-transition function.

6. The method of claim 1, further including performing runtime shielding.

7. The method of claim 6, wherein the runtime shielding includes, at a time step during runtime:
generating an action for current state using the policy;
identifying from the set of deterministic policies, a deterministic policy most likely to produce the generated action;
predicting a next state that would result from the action given the state-transition function;
checking an inductive invariant of the identified deterministic policy with the predicted next state;
responsive to the inductive invariant of the identified deterministic policy holding true, running the generated action; and
responsive to the inductive invariant of the identified deterministic policy not holding true, generating a safe action corresponding to the identified deterministic policy and running the safe action.

8. A computer program product comprising a computer readable storage medium having program instructions embodied therewith, the program instructions readable by a device to cause the device to:
receive a policy generated by deep reinforced learning, the policy for acting in an environment having a set of states;
responsive to determining that the policy is a non-deterministic policy, decompose the non-deterministic policy into a set of deterministic policies;
responsive to determining that a state-transition function associated with the set of states is unknown, approximate the state-transition function at least by training a deep neural network and transforming the deep neural network into a polynomial; and
verify using a constraint solver the policy with the state-transition function.

9. The computer program product of claim 8, wherein the device is caused to decompose the policy into the set of deterministic policies at least by:
dividing a probability distribution associated with the non-deterministic policy into a plurality of regions;
from each of the plurality of regions, selecting a sample,
wherein the set of deterministic policies includes the sample from each of the plurality of regions.

10. The computer program product of claim 9, wherein the sample represents a mean of a region from which the sample is selected.

11. The computer program product of claim 9, wherein the sample represents a mode of a region from which the sample is selected.

12. The computer program product of claim 8, wherein the device is caused to approximate the state-transition function at least by:
collecting a set of trajectories by running the policy in the environment, the set of trajectories including a sequence of state and action at each time step;
training the deep neural network based on the set of trajectories to predict a next state at next time step; and
transforming parameters of the deep neural network into a polynomial function using a I-th order Taylor approximation,
wherein the polynomial function used during the verifying as the state-transition function.

13. The computer program product of claim 8, wherein the device is further caused to perform runtime shielding.

14. The computer program product of claim 13, wherein the device is caused to perform runtime shielding at least by, at a time step during runtime:
generating an action for current state using the policy;
identifying from the set of deterministic policies, a deterministic policy most likely to produce the generated action;
predicting a next state that would result from the action given the state-transition function;
checking an inductive invariant of the identified deterministic policy with the predicted next state;
responsive to the inductive invariant of the identified deterministic policy holding true, running the generated action; and
responsive to the inductive invariant of the identified deterministic policy not holding true, generating a safe action corresponding to the identified deterministic policy and running the safe action.

15. A system comprising:
at least one processor;
a memory device coupled with the at least one processor;
the at least one processor configured to at least:
receive a policy generated by deep reinforced learning, the policy for acting in an environment having a set of states;
responsive to determining that the policy is a non-deterministic policy, decompose the non-deterministic policy into a set of deterministic policies;
responsive to determining that a state-transition function associated with the set of states is unknown, approximate the state-transition function at least by training a deep neural network and transforming the deep neural network into a polynomial; and
verify using a constraint solver the policy with the state-transition function.

16. The system of claim 15, wherein the processor is configured to decompose the policy into the set of deterministic policies at least by:
dividing a probability distribution associated with the non-deterministic policy into a plurality of regions;
from each of the plurality of regions, selecting a sample,
wherein the set of deterministic policies includes the sample from each of the plurality of regions.

17. The system of claim 16, wherein the sample represents a mean of a region from which the sample is selected.

18. The system of claim 16, wherein the sample represents a mode of a region from which the sample is selected.

19. The system of claim 15, wherein the processor is configured to approximate the state-transition function at least by:
collecting a set of trajectories by running the policy in the environment, the set of trajectories including a sequence of state and action at each time step;
training the deep neural network based on the set of trajectories to predict a next state at next time step; and
transforming parameters of the deep neural network into a polynomial function using a I-th order Taylor approximation,
wherein the polynomial function used during the verifying as the state-transition function.

20. The system of claim 15, wherein the processor is further configured to perform runtime shielding at least by, at a time step during runtime:
generating an action for current state using the policy;
identifying from the set of deterministic policies, a deterministic policy most likely to produce the generated action;
predicting a next state that would result from the action given the state-transition function;
checking an inductive invariant of the identified deterministic policy with the predicted next state;
responsive to the inductive invariant of the identified deterministic policy holding true, running the generated action; and
responsive to the inductive invariant of the identified deterministic policy not holding true, generating a safe action corresponding to the identified deterministic policy and running the safe action.
